(19) United States
(12) Patent Application Publication
(10) Pub. No.: US 2011/0011713 A1
(43) Pub. Date: Jan. 20, 2011

(54) Keyswitch and Supporting Structure Thereof

(75) Inventor: Chien Wei Su, Sijhih City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEHAVIOR TECH COMPUTER CORP., Sijhih City (TW)

(21) Appl. No.: 12/690,236

(22) Filed: Jan. 20, 2010

(30) Foreign Application Priority Data
Jul. 15, 2009 (CN) 200920161350.0

(51) Int. Cl. H01H 13/705

(52) U.S. Cl. 200/344

(57) ABSTRACT

A supporting structure for use in a keyswitch and the keyswitch are provided. The keyswitch comprises a keycap, a base and the supporting structure. The supporting structure comprises two supporting arms and two latch sets, wherein the two supporting arms intersect based on a virtual axis and are disposed between the keycap and the base. Each of the latch sets is correspondingly disposed on two opposite ends of each of the supporting arms. The two supporting arms are adapted to be detachably connected with each latch set and perform an arc motion with respect to the virtual axis, therefore, moving the keycap upwards and downwards above the base.

This application claims priority to Chinese Patent Application No. 200920161350.0 filed on Jul. 15, 2009; the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a keyswitch, and more particularly, to a supporting structure for a keyswitch.

2. Descriptions of the Related Art

As a common kind of input device for computers, keyboards play an import role in communication between users and computers. As a result, importance is placed on the comfort of the keyboard keyswitches. However, due to the small size of the keyswitches, they are commonly brittle so damages often occur during the assembly and processing of the parts. Accordingly, continuous improvement has been made on the keyswitch structure of keyboards in the prior art to cater to the demands of users and improve the assembly efficiency.

FIG. 1 illustrates a schematic cross-sectional view of a conventional keyswitch structure is shown therein. The conventional keyswitch 1 comprises a keycap 11, a base 12 and a supporting structure 2. The supporting structure 2 has two supporting arms 21 and a latch set 22. The latch set 22 connects the two supporting arms 21 so that the two supporting arms 21 are disposed crosswise between the keycap 11 and the base 12. The keycap 11 is supported on the base 12 by the two supporting arms 21 of the supporting structure 2, and moves up and down with respect to the base 12 when the two supporting arms 21 rotates with respect to each other about the latch set 22.

The aforesaid keyswitch structure has several disadvantages, which will be briefed as follows. First, in terms of the design of the limiting structure that controls the extent of the up-and-down movement of the keycap, the aforesaid keyswitch structure typically needs a special limiting structure for use to control the amplitude of the up-and-down movement of the keycap. This makes the conventional keyswitch structure much more complex and difficult to assemble. For example, in FIG. 1, the limiting structure of the keyswitch is two slide rails 13 disposed on the keycap 11 and the base 12 respectively and two round shafts 211 disposed at one end of each supporting arm 21 respectively. More specifically, the round shafts 211 of the supporting arms 21 are received in one of the slide rails 13 of the keycap 11 and the base 12 respectively, and are restrained by the slide rails 13 to make linear movement within the slide rails 13. This limiting structure operates in the following principle: by controlling the length of the two slide rails 13, the extent to which the two supporting arms 21 rotate with respect to each other can be indirectly controlled to determine the positions of the top dead point and bottom dead point as well as the amplitude of the up-and-down movement of the keycap 11.

Furthermore, another problem of the aforesaid conventional keyswitch structure is that it is difficult to assemble. In particular, the slide rail 13 disposed on the base is of an open type, so the round shaft 211 tends to move out of this slide rail 13 to cause the inadequate stability of the two supporting arms 21 after being assembled, thereby compromising the structural stability of the keyswitch 1 as a whole. Additionally, the slide rail 13 disposed on the keycap 11 is of a closed structure and a proper direction has to be followed when assembling the supporting structure 2; if the supporting structure 2 is assembled in the wrong direction, an improper force applied during the process of reworking or disassembling often leads to the fracture of the slide rail 13 or even degradation in the yield rate of the product.

In view of this, it is highly desirable in the art to provide a simplified keyswitch structure to improve the efficiency and yield rate of the assembly process of keyswitches.

### SUMMARY OF THE INVENTION

To solve the aforesaid problem, an objective of the present invention is to provide a keyswitch and a supporting structure thereof. By integrating the conventional limiting structure and the supporting structure into a new supporting structure, the complexity of the conventional keyswitch structure is decreased, thereby improving both the efficiency and yield rate of the assembling process of keyswitches.

The keyswitch of the present invention comprises a keycap, a base and the supporting structure. The supporting structure comprises two supporting arms and two latch sets. The two supporting arms intersect based on the virtual axis and are disposed between the keycap and the base wherein the virtual axis is a co-axis of the two supporting arms. The two latch sets are disposed to two opposite ends of each of the supporting arms with the virtual axis as the center. The two supporting arms are detachably connected with each of the latch sets and perform an arc motion with respect to the virtual axis so that the keycap is adapted to be moved upwards and downwards above the base. In this way, the two latch sets on the two supporting arms are able to limit the extent to which the two supporting arms rotate, so as to effectively control the amplitude of the up-and-down movement of the keycap with respect to the base, thereby accomplishing the purpose of limiting the position and simplifying the keyswitch structure.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional keyswitch;

FIG. 2 is a cross-sectional view of the supporting structure of the present invention;

FIG. 3A is a schematic view illustrating how the supporting structure of the present invention is assembled;

FIG. 3B is a schematic view illustrating how the supporting structure of the present invention is assembled properly;

FIG. 4 is a schematic view illustrating operation of the keyswitch of the present invention;

FIG. 5A is a top view of an outboard supporting arm of the present invention;

FIG. 5B is a cross-sectional view of an outboard supporting arm of the present invention; and

FIG. 5C is a schematic enlarged view of the guiding recess of the present invention.

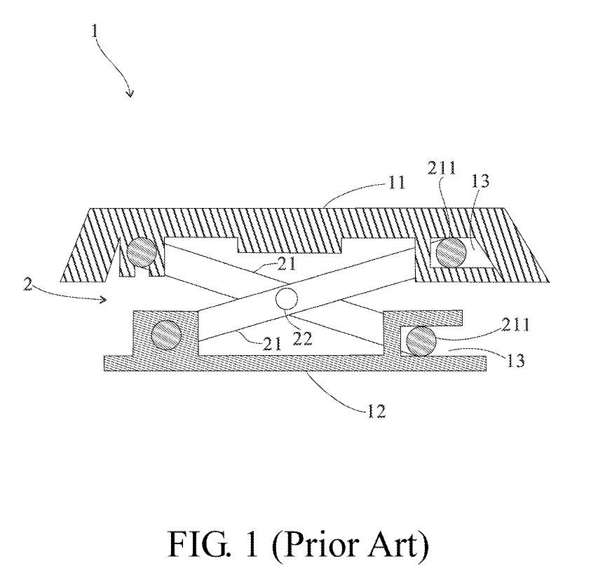

### DESCRIPTION OF THE PREFERRED EMBODIMENT

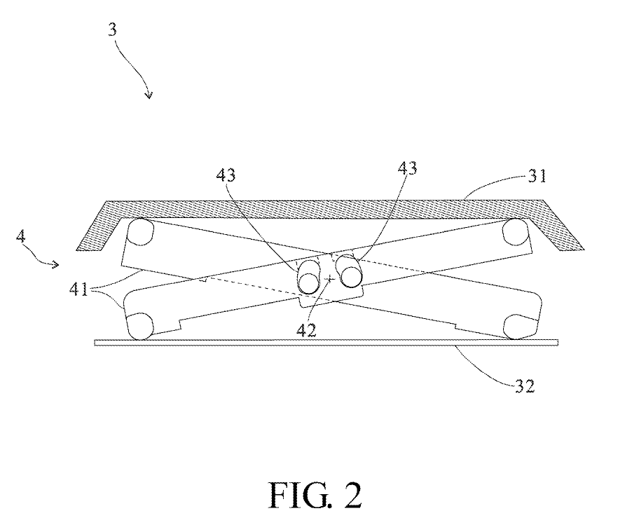

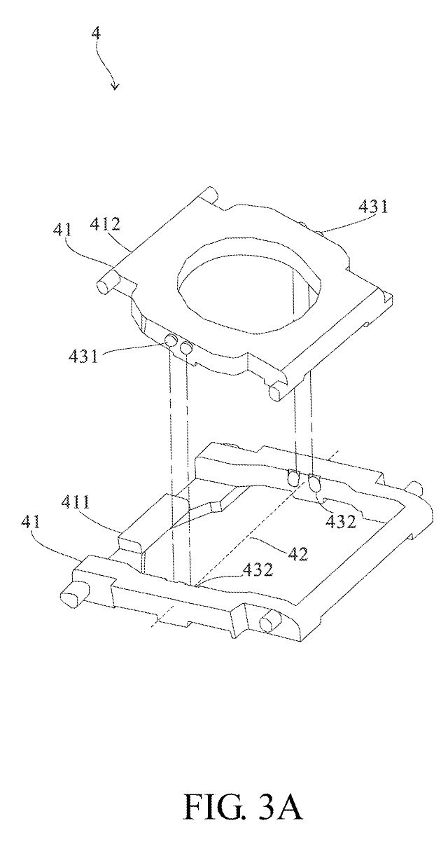

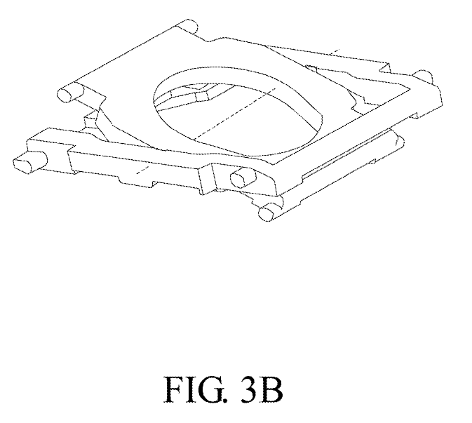

As shown in FIG. 2, a schematic cross-sectional view of a keyswitch 3 according to an embodiment of the present invention is shown therein. The keyswitch 3 comprises a keycap 31, a base 32 and a supporting structure 4. The present invention is unique in that the supporting structure 4 comprises two supporting arms 41 and two latch sets 43. Each of the supporting arms 41 is generally in a square form (as shown in FIG. 3A), which integrates the conventional supporting arm and the limiting structure together. In particular, the two supporting arms 41 may be an outboard supporting arm 411 and an inboard supporting arm 412 (as shown in FIG. 3A) respectively, and the two latch sets 43 are disposed at two opposite ends of the supporting arms 41 with a virtual axis 42 as the center, wherein the virtual axis 42 is a co-axis of the two supporting arms. The two supporting arms 41 are detachably connected with each other by means of the latch sets 43 so that the two supporting arms 41 are disposed crosswise, with the virtual axis 42 as the central axis, between the keycap 31 and the base 32 to support the keycap 31 on the base 32 and to move the keycap 31 upwards and downwards with respect to the base 32.

The present invention is unique in that the supporting structure 4 uses two latch sets 43 to connect the two supporting arms 41. More specifically, the two latch sets 43 are adapted to perform an arc motion with respect to the virtual axis 42 to drive the keycap 31 to move upwards and downwards relative to the base 32. By means of the arc motion, the angle to which the two supporting arms 41 rotate relative to each other can be controlled to effectively control the amplitude of the up-and-down movement of the keycap 31 with respect to the base 32. The method in which the embodiment of the present invention is integrated and actuated will be detailed as follows.

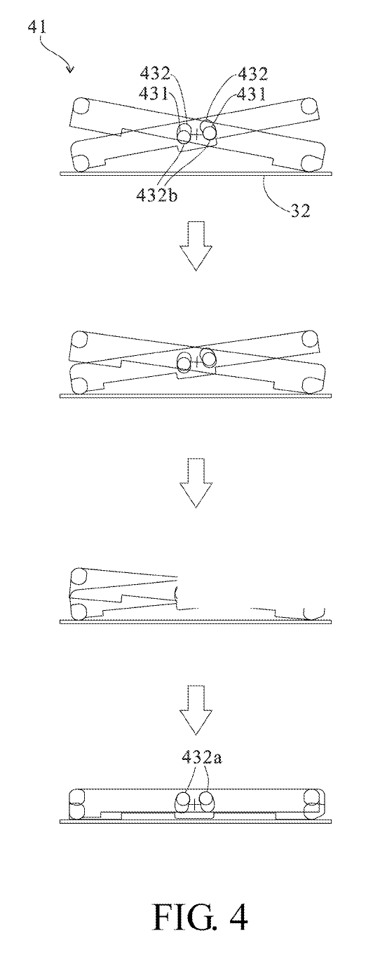

With references to FIGS. 3A, 3B and 4 together, a supporting structure 4 according to an embodiment of the present invention is shown therein. FIG. 3A is a schematic view illustrating how the supporting structure 4 is assembled. Each of the latch sets 43 comprises two shafts 431 and two sliding grooves 432 disposed at two opposite side edges of the square structure of the outboard supporting arm 411 and inboard supporting arm 412 respectively. In the preferred embodiment, each of the sliding grooves 432 is an arc groove and each of the shafts 431 is an outward curved surface, so that when the shafts 431 slide in the sliding grooves 432, the contact area and, consequently, the frictional force between the shafts 431 and the sliding grooves 432 is reduced, making the operation of the keyswitch 3 smoother.

In more detail, the two latch sets 43 comprise four shafts 431 and four sliding grooves 432 in total, which are disposed at two opposite side edges of the outboard supporting arm 411 and the inboard supporting arm 412 respectively. For example, in FIG. 3A, there are two shafts 431 disposed at the proximal side edge and distal side edge of the inboard supporting arm 412 respectively; similarly, there are two sliding grooves 432 disposed at the proximal side edge and distal side edge of the outboard supporting arm 411 respectively. The four shafts 431 on the two opposite side edges of the inboard supporting arm 412 are received in the four sliding grooves 432 of the outboard supporting arm 411 correspondingly so that each of the shafts 431 is adapted to perform an arc motion in the respective sliding groove 432 with respect to the virtual axis 42. It shall be appreciated that the example in which the two latch sets 43 are disposed in the two supporting arms 41 is only provided for illustration but not limitation, and modifications may be made readily by those of ordinary skill in the art upon reviewing the disclosure of the present invention. For example, the four shafts 431 and the four sliding grooves 432 of the two latch sets 43 may be disposed at two opposite side edges of the outboard supporting arm 411 and the inboard supporting arm 412 respectively in such a way that each of the opposite side edges has a shaft 431 and a sliding groove 432. Other modifications and combinations of the latch sets will not be further described herein.

Next, FIG. 4 illustrates a schematic view illustrating the continuous actuation of the keyswitch 3. It shall be appreciated that although the keycap 31 is omitted from depiction, it can be devised by those skilled in the art upon reviewing the disclosure of the present invention. When each of the shafts 431 moves to the tail end of the respective sliding groove 432, the two supporting arms 41 intersect to form a maximum included angle and the key cap 31 moves to the highest position with respect to the base 32. When the keycap 31 is depressed to gradually moves downward, the two supporting arms 41 move towards each other with the included angle therebetween decreasing correspondingly. In this case, each of the shafts 431 will move from the tail end 432b of the respective sliding groove 432 towards the top end 432a. When each of the shafts 431 moves to the top end 432a of the respective sliding groove 432, the two supporting arms 41 intersect to form a minimum included angle and the keycap 31 moves to the lowest position with respect to the base 32. Because each of the shafts 431 performs an arc motion within the sliding groove 432, the maximum included angle and the minimum included angle may be adjusted by adjusting the arc length of the sliding grooves 432. Thereby, the amplitude of the up-and-down movement of the keycap 31 with respect to the base 32 can be controlled to restrain the movement to be within an appropriate range and simplify the way in which the supporting structure 4 connects with the keycap 31 and the base 32.

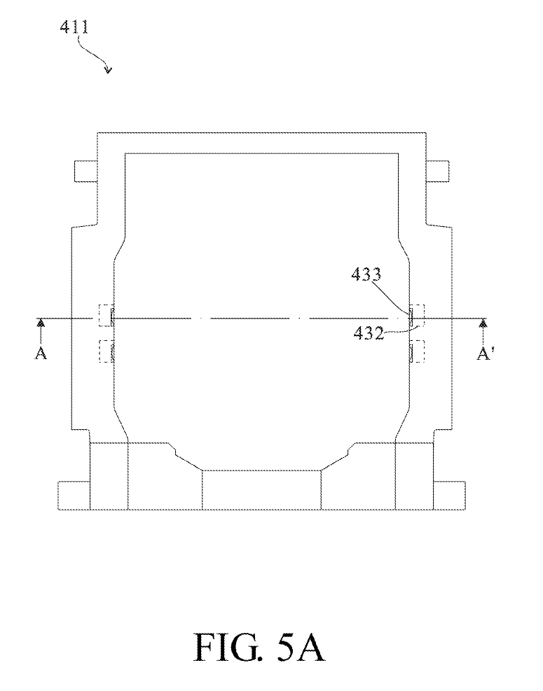

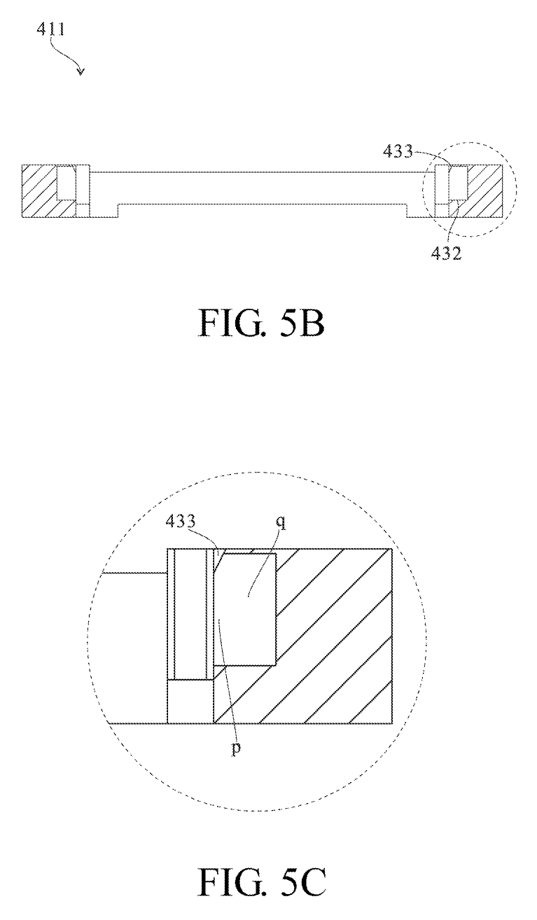

FIGS. 5A, 5B and 5C together illustrate the preferred embodiment of the present invention. FIG. 5B is a schematic cross-sectional view of FIG. 5A taken along line A-A′, and FIG. 5C is a schematic partially enlarged view of FIG. 5B. In particular, each of the sliding groove 432 of the present invention comprises a guiding recess 433 disposed on each of the outboard supporting arm 411. Because the guiding recess 433 is disposed at the lateral end of the arc-shaped sliding groove 432, the sliding groove 432 is divided into two portions, namely, an opening slot p and an enclosing slot q. The opening slot p is favorable for guiding the shaft 431 of the supporting arm into the respective sliding groove 432 during the assembly process to prevent damage to the two supporting arms 41 due to an excessive force. The enclosing slot q makes it less likely for each of the shafts 431 to move out of the respective sliding slot 432, thereby improving the stability of the supporting structure 4.

According to the above descriptions, as compared to the conventional supporting structure for a keyswitch, the supporting structure of the present invention can directly control an angle range to which the two supporting arms rotate relative to each other by using the shafts and the sliding grooves in combination for position limiting purposes, thereby controlling the amplitude of the up-and-down movement of the keycap with respect to the base within an appropriate range. The assembly process is made easier and the keyswitch move smoother and is more stable via guiding recesses disposed on the sliding grooves of the support arms. Furthermore, compared to the conventional keycap and conventional base, the keycap and the base of the present invention have simpler structures, which can improve both the efficiency and yield rate of the assembly process of the keyswitch and enhance the convenience during the reworking process.

The above disclosure is related to the detailed technical contents and inventive features thereof. People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A supporting structure for a keyswitch, the keyswitch comprising a keycap and a base, and the supporting structure comprising:
two supporting arms, intersecting based on a virtual axis and being disposed between the keycap and the base, wherein the virtual axis is a co-axis of the two supporting arms; and
two latch sets, disposed to two opposite ends of each of the supporting arms with the virtual axis as a center, wherein the supporting arms are detachably connected with each of the latch sets and perform an arc motion with respect to the virtual axis so that the keycap is adapted to be moved upward and downward above the base.

2. The supporting structure as claimed in claim 1, wherein each of the latch sets comprises two shafts and two sliding grooves disposed to two opposite side edges of each supporting arm respectively, and each of the shafts is received in each of the sliding grooves to perform the arc motion with respect to the virtual axis.

3. The supporting structure as claimed in claim 2, wherein while each of the shafts moving to a terminal portion of each of the sliding grooves, the two supporting arms intersect and are disposed between the keycap and the base to form a maximum included angle and the key cap moves to a highest position with respect to the base.

4. The supporting structure as claimed in claim 3, wherein while each of the shafts moving to a top portion of each of the sliding grooves, the two supporting arms intersect and are disposed between the keycap and the base to form a minimum included angle and the key cap moves to a lowest position with respect to the base.

5. The supporting structure as claimed in claim 2, wherein each of the shafts is an outward curved surface.

6. The supporting structure as claimed in claim 2, wherein each of the sliding grooves is an arc groove.

7. The supporting structure as claimed in claim 2, wherein each of the sliding grooves comprises a guiding recess disposed on each of the supporting arms to form an opening slot and an enclosing slot for each of the shafts adapted to be guided into each of the sliding grooves via the guiding recess.

8. The supporting structure as claimed in claim 7, wherein each of the guiding recesses is disposed on an end of each sliding groove.

9. The supporting structure as claimed in claim 1, wherein the two supporting arms comprise an outboard supporting arm and an inboard supporting arm.

10. A keyswitch for a keyboard, comprising:
a keycap;
a base; and
a supporting structure comprising:
two supporting arms, intersecting based on a virtual axis and being disposed between the keycap and the base, wherein the virtual axis is a co-axis of the two supporting arms; and
two latch sets, disposed to two opposite ends of each of the supporting arms with the virtual axis as a center, wherein the supporting arms are detachably connected with each of the latch sets and perform an arc motion with respect to the virtual axis so that the keycap is adapted to be moved upward and downward above the base.

11. The keyswitch as claimed in claim 10, wherein each of the latch sets comprises two shafts and two sliding grooves being disposed to two opposite lateral sides of each supporting arm respectively, and each of the shafts is received in each of the sliding grooves to perform the arc motion with respect to the virtual axis.

12. The keyswitch as claimed in claim 11, wherein while each shaft moving to a terminal portion of each sliding groove, the two supporting arms intersect to form a maximum included angle and the key cap moves to the highest position with respect to the base.

13. The keyswitch as claimed in claim 12, wherein while each shaft moving to a top of each sliding groove, the two supporting arms intersect to form a minimum included angle and the key cap moves to the lowest position with respect to the base.

14. The keyswitch as claimed in claim 13, wherein each of the shafts is an outward curved surface.

15. The keyswitch as claimed in claim 14, wherein each of the sliding grooves is arc groove.

16. The keyswitch as claimed in claim 15, wherein each of the sliding grooves comprises a guiding recess disposed on each of the supporting arms to form an opening slot and an enclosing slot.

17. The keyswitch as claimed in claim 16, wherein each guiding recess is disposed on tip of each sliding groove.

18. The keyswitch as claimed in claim 10, wherein the two supporting arms comprises an outboard supporting arm and an inboard supporting arm.
